(19) United States
(12) Patent Application Publication
(10) Pub. No.: US 2014/0265484 A1
(43) Pub. Date: Sep. 18, 2014

(54) APPARATUS FOR SEATING TWO OR MORE CHILDREN IN A BACKSEAT OF A VEHICLE

(71) Applicants: David ELHARAR, Tel-Aviv (IL); Shirly BRANDES-BALLAN, Ramat-Hasharon (IL)

(72) Inventors: David ELHARAR, Tel-Aviv (IL); Shirly BRANDES-BALLAN, Ramat-Hasharon (IL)

(21) Appl. No.: 13/794,843

(22) Filed: Mar. 12, 2013

(51) Int. Cl. B60N 2/28

(52) U.S. Cl. CPC B60N 2/28
USPC 297/232

(57) ABSTRACT

The subject matter discloses a vehicle seat for children, including a bench on which a first child and a second child sit while in the vehicle seat; a back support to provide back support to the child sitting in the children vehicle sit; a partition unit in the center of the children vehicle sit, wherein the partition unit protrudes from the bench and defines a first seat and a second seat, wherein the first seat and the second seat are two separate seats; two safety belt units to secure two children sitting in the children car seat, wherein one safety belt unit is positioned in the first seat of the vehicle seat and another safety belt unit is positioned in the second seat of the vehicle seat; the bench is securely affixed to the back support; the partition unit is affixed to the bench.

### FIELD OF THE INVENTION

The subject matter relates generally to children's car seats. More specifically, the subject matter relates to a car seat for two children.

### BACKGROUND OF THE INVENTION

With the increase of gas prices, car owners are looking to find ways to efficiently use space available in smaller cars. Many vehicles have a limited space in the back, which is arranged to fit up to three passengers. Car owners look for ways in which they may use the back seat more efficiently to seat as many individuals as possible, while still complying with safety regulations required by the law. Car owners also prefer to use vehicles of smaller sizes, which have relatively lower prices and low maintenance costs. Furthermore, large vehicles, such as SUVs, are more problematic when finding a parking space.

In many vehicles, three adults or children can seat in the back seat of the vehicle. When the owner of the vehicle is required to place baby seats to the back seat of the vehicle, the free space at the back seat dramatically decreases. When the owner of the vehicle has two children and is required to place two baby seats, it is very inconvenient for a third person to seat between the two baby seats. Further, in standard vehicles having a back seat of approximately 1.5 meters, it is impossible to place three children of ages 0-8 according to known standard regulations.

### SUMMARY

It is an object of the subject matter to disclose a vehicle seat for children, comprising: a bench on which a first child and a second child sit while in the vehicle seat; a back support to provide back support to the child sitting in the children vehicle sit; a partition unit in the center of the children vehicle sit, wherein the partition unit protrudes from the bench and defines a first seat and a second seat, wherein the first seat and the second seat are two separate seats; two safety belt units to secure two children sitting in the children car seat, wherein one safety belt unit of the two safety belt units is positioned in the first seat of the vehicle seat and another safety belt unit of the two safety belt units is positioned in the second seat of the vehicle seat; wherein the bench is securely affixed to the back support; wherein the partition unit is affixed to the bench.

In some cases, each safety belt unit of the two safety belt units further comprise a buckle; one or more straps, wherein one end of a strap of the one or more straps comprises a metal fitting; wherein said metal fitting is inserted into the buckle to lock the child into the children vehicle seat.

In some cases, the back support is molded with the partition.

In some cases, the children vehicle seat is attached to the back seat of the vehicle with an ISOFIX type attachment.

In some cases, the children vehicle seat further comprises a connection plate to connect a baby carrier to the children vehicle seat, wherein the baby carrier is the size of a single child on the children vehicle seat.

In some cases, the connection plate is an ISOFIX type attachment.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 shows a children vehicle seat for seating two children, according to some exemplary embodiments of the subject matter;

FIG. 2 shows a side view of a children vehicle seat for seating, two children, according to some exemplary embodiments of the subject matter;

FIG. 3 shows a children vehicle seat connected to a back seat of a vehicle, according to some exemplary embodiments of the subject matter;

FIG. 4 shows a children vehicle seat inside a vehicle with children sitting in the children vehicle seat, according to some exemplary embodiments of the subject matter;

FIGS. 5A, 5B, 5C show a children vehicle seat with baby carriers, according to some exemplary embodiments of the subject matter; and,

FIG. 6 shows a backseat of a vehicle with two children vehicle seats, according to some exemplary embodiments of the subject matter.

### DETAILED DESCRIPTION

The subject matter discloses a children vehicle seat for seating two children in a space designated for one adult passenger in the vehicle, according to some exemplary embodiments of the subject matter.

FIG. 1 shows a children vehicle seat for seating two children, according to some exemplary embodiments of the subject matter. The children vehicle seat 100 is configured to be positioned in the back seat of the vehicle and to be sized in a manner which enables two children to sit comfortably. As prior art requires two separate seats, each of width of 45-60 centimeters, and the width of the entire back seat of vehicles in categories of compact car and mid-size car is about 130-145 centimeters. These categories include Ford Focus and Ford Mondeo. Placing two separate children seats leaves only 30-40 centimeters for another passenger to sit at the back seat of the vehicle. The width of the vehicle seat of the disclosed subject matter is in the range of 55-70 centimeters, which leave 70-80 centimeters to other passengers. The width of the vehicle seat of the subject matter enables placing two vehicle seats, where each of the vehicle seats is configured for two children, so four children can seat comfortably at the back seat of the vehicle at the same time.

The children vehicle seat 100 comprises a bench 105 on which a first child and a second child may be seated. The bench 105 is connected to a back support 110, which enables the first child and the second child to sit comfortably in the children vehicle seat 100. The children vehicle seat 100 is molded out of a soft material to ensure the comfort of the two children sitting in the children vehicle seat 100, for example the bench 100 and the back support 110 are composed of foam, cotton product, or the like. The bench 105 and back support 110 are fixed elements. In some cases, the children vehicle seat 100 is made so the bench and the back support 110 are molded from the same piece of material. The back support 110 comprises a partition unit 120 protruding from the bench 105 which defines two separate seats at the bench, a first seat 152 for the first child and a second seat 153 for the second child. The partition unit 120 ensures that each child is provided enough space to sit comfortably in the children vehicle seat 100 at the back seat of the vehicle. In some exemplary cases, the partition is molded as part of the back support 110, while in other exemplary cases, the partition 120 maybe a separate unit that may be removable to fit a larger child, or a large baby carrier.

The children vehicle seat 100 comprises a right wall 130 and a left wall 140 to further support children seated in the children vehicle seat 100. The first child is seated between the right wall 130 and the partition unit 120, which hold the child in the first seat 152 and ensure that the first child does not move excessively in the children vehicle seat 100 due to the movement of the vehicle connected to the children vehicle seat 100. The sitting area thr child in the children vehicle seat 100 may be of a depth of at least 30 centimeters, at least 20 centimeters width and a height of at least 36 centimeters.

The children vehicle seat 100 comprises of two seat belt units, for example a first child seat belt unit and a second child seat belt unit. The first child seat belt unit comprises a buckle 150, a right strap 170 and a left strap 172. The right strap 170 comprises a left metal fitting 175 which may be inserted into the buckle 150 to secure the right strap 170 on the first child. The left strap 172 comprises a left metal fitting 177 that is inserted into the buckle 150 to secure the first child from the opposite side of the right strap 170. For example, a first child being seated in the children vehicle seat 100 would be seated so the child's back is up against the back support 110 and the child's shoulders are comfortably between the right wall 130 and the partition unit 120. The right strap 170 is passed over the child's right shoulder and in from of the child so the right metal fitting 175 is inserted into the buckle 150 and secured. The left strap 172 is passed over the child's left shoulder and in front of the child so the left metal fitting 177 is inserted into the buckle 150. The first child is then securely strapped into the first seat 152 of the child vehicle seat 100. To remove the right strap 170 and the left strap 172 from the child, a release button (not shown) on the buckle 150 is pressed to release both metal fittings 175, 177 from the buckle 150 and the first child may move out of the chair or be removed by an adult. The second seat belt unit comprises a buckle 160 and a right strap 180 and a left strap 162. The right strap 180 comprises a metal fitting 165 which may be inserted into the buck 160 to secure the right, strap 180 on the first child. The left strap 182 comprises a metal fitting 187 that is inserted into the buckle 160 to secure the second child from the opposite side of the right strap 180.

FIG. 2 shows a side view of children vehicle seat for seating two children, according to some exemplary embodiments of the subject matter. The children vehicle seat 200 comprises a bench 205 on which a first child and a second child may seat on. The length of the bench 205 is such that the first child and second child are able to bend their legs and sit comfortably in the children vehicle seat 200 in a similar manner to larger individual sitting in a standard seat in a vehicle. The bench 205 is connected to a back support 210. In some cases the back support 210 may comprise a back cushion 207 for further support of a child seated in the children vehicle seat 200. The back support 210 is convex shaped to fit into the crevice of a vehicle seat to prevent the children vehicle seat 200 from excessive movement. The children vehicle seat 200 comprises a first child seat belt unit 250 and a second child seat belt unit 260 to secure each child into the children vehicle seat 200. The children vehicle seat 200 also comprises a partition unit 220 and two walls for supporting the first child and the second child, a first wall 230 and a second wall (not shown).

FIG. 3 shows a children vehicle seat connected to a back seat of a vehicle, according to some exemplary embodiments of the subject matter. The children vehicle seat 300 is placed in the middle of a vehicle backseat 310. The children vehicle seat 300 is strapped to the vehicle backseat 310 using a seat belt 320. The seat belt 320 is strapped across front of the children vehicle seat 300 between a bench and a back support. In some exemplary embodiments of the subject matter, the children vehicle seat 300 may comprise an attachment plate (not shown) which is used to attach the children vehicle seat 300 to a seat attachment (not shown), for example an ISOFIX type attachment. In this exemplary embodiment the children vehicle seat 300 is arranged in the center of the vehicle backseat 310, which still enables two other passengers to sit on each side of the children vehicle seat 300.

FIG. 4 shows a children vehicle seat inside a vehicle with children sitting in the children vehicle seat, according to some exemplary embodiments of the subject matter. The children vehicle seat 400 is attached to a backseat 450 of the vehicle 405. A first child 410 and a second child 420 are seated in the vehicle car seat 400 while a first passenger 430 and a second passenger 440 sit in the two remaining spaces of the backseat 450. The first child 410 is strapped into the children vehicle seat 400 with a first seat belt 415, and the second child 420 is strapped into the children vehicle seat 400 with a second seat belt 415. The first child 410 and the second child 420 are seated in the children vehicle seat 400 in such a manner so that they have enough space between them to be comfortable and still secured safely. The children vehicle seat 400 is compact enough that it provides enough space for the first passenger 430 and the second passenger 440 on the backset 450. For example, when the width of the backseat 450 is 150 centimeters and the width of the children vehicle seat 400 is 60 centimeters, two passengers can sit in 45 centimeters each.

FIGS. 5A, 5B, 5C show a children vehicle seat with baby carriers, according to some exemplary embodiments of the subject matter. The children vehicle seat 500 may comprise a cushion 505 on which a child sits while in the children vehicle seat 500. The cushion 505 may be removable to enable placing a baby seat 520 into spot of a single child in the children vehicle seat 500. In some cases, the children vehicle seat 500 may comprise a connection plate 510 underneath the cushion 505 to enable safely connecting the baby seat 520 to the children vehicle seat 500, and preventing the baby seat 520 from falling out of the children vehicle seat 500. In some exemplary embodiments of the subject matter the baby seat 520 is restrained by a seat belt unit 530 that attaches the baby seat 520 to the children vehicle seat 500. The baby seat 520 is positioned in the children vehicle seat 500 so a baby 525 inside the baby seat 520 is lying down in a safe manner. In some exemplary embodiments of the subject matter, the connection plate 510 is an ISOFIX type attachment, in which case the cushion 505 does not have to be removed from the children vehicle seat 500 but is rather part of a mold of the children vehicle seat 100. FIG. 5C shows attaching a second baby seat 530 to the children vehicle seat 500, according to some exemplary embodiments of the subject matter. The second baby seat 530 holds a second baby 535. In some cases, the connection plates are configured to connect a booster chair to the children vehicle seat 500, to enable children of ages ranged between 3 and 9 years to use the children vehicle seat 500. In some other cases, two booster chairs may be mounted on the cushion 505 of the children vehicle seat 500 and the children are secured to the children vehicle seat 500 using safety belts. Other types of seats for children and infants known to a person skilled in the art may also be connected to the children vehicle seat 500 in pairs, as disclosed in the subject matter.

FIG. 6 shows a backseat of a vehicle with two children vehicle seats, according to some exemplary embodiments of the subject matter. As standard width of a backseat is in the range of 140-160 centimeters, it is simple to place two children vehicle seats of the disclosed subject matter, each of which is in the range of 55-70 centimeters width. A first children vehicle seat 610 is attached to the backseat 600 at one end of the backseat 600. The first children vehicle seat 610 may seat a first child 615 and a second child 620. A second children vehicle seat 640 is attached to the other end of the backseat 600. A first baby carrier 645 and a second baby carrier 650 may be connected to the second children vehicle seat 640. The two children vehicle seats enable an adult passenger 630 to sit comfortably in the middle seat of the vehicle. In other exemplary embodiments of the subject matter, the two children vehicle seats may be placed one next to the other, for example the first children vehicle seat 610 is placed at the end of the backseat 600 and the second children vehicle seat 640 is placed in the middle sitting space. The larger passenger 630 may then sit comfortably in at the end of the backseat 600 that is still vacant.

While the disclosure has been described with reference to exemplary embodiments, it will be understood by those skilled in the art that various changes may be made and equivalents may be substituted for elements thereof without departing from the scope of the subject matter. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this subject matter, but only by the claims that follow.

1. A vehicle seat for children, comprising:
a bench on which a first child and a second child sit while in the vehicle seat;
a back support to provide back support to a child sitting in the vehicle seat;
a partition unit in the center of the vehicle seat, wherein the partition unit protrudes from the bench and defines a first seat and a second seat, wherein the first seat and the second seat are two separate seats;
two safety belt units to secure two children sitting in the vehicle seat, wherein one safety belt unit of the two safety belt units is positioned in the first seat of the vehicle seat and another safety belt unit of the two safety belt units is positioned in the second seat of the vehicle seat;
wherein the bench is securely affixed to the back support;
wherein the partition unit is affixed to the bench.

2. The vehicle seat of claim 1, wherein each safety belt writ of the two safety belt units further comprise:
a buckle;
one or more straps, wherein one end of a strap of the one or more straps comprises a metal fitting;
wherein said metal fitting is inserted into the buckle to lock the child into the vehicle seat.

3. The vehicle seat of claim 1, wherein the back support is molded with the partition unit.

4. The vehicle seat of claim 1, wherein the vehicle seat is attached to the back seat of a vehicle with an ISOFIX type attachment.

5. The children vehicle seat of claim 1, further comprises a connection plate to connect a baby carrier to the vehicle seat, wherein the baby carrier is the size of a single child on the vehicle seat.

6. The vehicle seat of claim 5, wherein the connection plate is an ISOFIX type attachment.
